(19) United States
(12) Patent Application Publication
(10) Pub. No.: US 2010/0203876 A1
(43) Pub. Date: Aug. 12, 2010

(54) INFERRING USER PROFILE PROPERTIES BASED UPON MOBILE DEVICE USAGE

(75) Inventor: Dilip Krishnaswamy, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/369,676

(22) Filed: Feb. 11, 2009

(51) Int. Cl. H04M 3/00

(52) U.S. Cl. 455/418

(57) ABSTRACT

Demographic information regarding a user of a mobile device is inferred by observing the user's mobile device usage behavior. Bayesian probability principles are applied to the observed usage behavior in order to infer a most likely demographic category classification. Probabilities of the user being a member of various demographic category classifications may be obtained from population surveys. Conditional probabilities of the user being a member of a behavior category classification given a demographic category classification may also be obtained from population surveys. A most likely user demographic category can be determined by calculating the product of the probability of the user being a member of each of the demographic category classifications and the first conditional probability of the user being a member of the behavior category classification, and identifying the demographic category classification that yields a maximum relative likelihood. The user demographic category may alternatively be determined by a table look up using the determined behavior category classification.

### BACKGROUND

1. Field

The present invention relates generally to mobile device technologies, and more particularly to a system and method for inferring user profile properties about a user based upon the user's mobile device usage.

2. Background

Various user profile properties of a mobile device user may encompass any characteristic that defines or describes the user. For example, user profile properties may encompass various traditional demographic category classifications. Traditional demographic categories may include race, age, income, disabilities, mobility (in terms of travel time to work or number of vehicles available), educational attainment, home ownership, employment status, location, etc. Each user profile property may in turn have or be organized into different classifications. For example, one user profile property may be gender which has two classifications, i.e., male or female. Another user profile property may be age which can be organized into age group classifications, such as 13-24 years old, 25-44 years old, 45-54 years old and 55 years old or older. Knowledge of mobile device user profile properties may be useful in a whole host of applications.

For example, by determining that a user is a senior citizen (i.e., senior citizen class of the age property category) a mobile device could be configured to automatically adjust the size of display icons so they are easier to see. Similarly, other mobile device settings and preference (e.g., volume settings, ringtones, wallpapers, etc.) may also be automatically adjusted depending upon the age profile of the user. As another example, by determining the properties of the mobile device user, an application running on the mobile device may be configured to filter mass marketing messages so that only those relevant to the user may be displayed. One of skill in the art would appreciate that a wide variety of applications may exploit a mobile device user's properties.

Nevertheless, the various mobile device user profile properties may be difficult to obtain. While the mobile device may be configured to request such information from the user, the user may decline for a variety of reasons. For example, users may have privacy concerns that dissuade them from providing such information to their mobile device. Even if users respond to user profile property questions posed by the mobile device, they may enter inaccurate information. Some may enter incorrect data by mistake, while others may purposefully respond to such questions with inaccurate information due to their privacy concerns. In addition, when users replace or update their mobile devices, the new device may have to request the user profile property information again, which may frustrate users.

### SUMMARY

The various embodiments provide methods, systems and apparatus for inferring user profile properties based on the user's usage behavior of a mobile device and derived information from a population of users. Mobile device usage events for any of a variety of usage behavior categories are logged. Based upon the logged mobile device usage events usage behavior category classifications are determined. Using Bayesian probability principles, the conditional probability of the mobile device user falling into a particular user profile property category classification given a usage behavior category classification may be determined. A user profile property category classification may be inferred based upon determining the classification of a user profile property category with the greatest probability. Various embodiments infer user profile property information based upon the user's behaviors while conserving processing power, memory, power levels of the mobile device as well as safeguarding a user's privacy.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a process flow diagram of an embodiment method for inferring user profile properties based on their mobile device usage.

FIG. 2 is a process flow diagram illustrating an embodiment method for determining the usage behavior classification based on a user's mobile device usage.

FIG. 3 is a process flow diagram of an embodiment method for inferring user profile properties based on the user's various classification(s) within N usage behavior categories.

FIG. 4 is a process flow diagram of an embodiment method for inferring user profile properties by calculating the probability of a user falling within a user profile property category classification given information regarding a plurality of usage behavior categories.

FIG. 5 is a process flow diagram of alternative method for inferring user profile properties by looking up a user's most probable user profile property category classification in a derived table of user profile property category classification probability values.

FIG. 6 is a process flow diagram of an alternative method performed by a user's mobile device for inferring user profile properties by accessing a remote server.

FIG. 7 is a process flow diagram of an alternative method performed by a remote server for inferring user profile properties based upon a user's mobile device usage.

FIG. 8 is a circuit block diagram of an example mobile device suitable for use with the various embodiments.

FIG. 9 a system block diagram of a wireless network including a number of mobile devices connected through a communication network to a remote server suitable for use with the various embodiments.

FIG. 10 is a circuit block diagram of an example remote server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the term “mobile device” refers to any one or all of cellular telephones, personal data assistants (PDA's), laptop computers, palm-top computers, wireless electronic mail receivers (e.g., the Blackberry® and Treo® devices), multimedia Internet enabled cellular telephones (e.g., the iPhone®), Global Positioning System (GPS) receivers and similar personal electronic devices which include a programmable processor and memory. For purposes of the embodiments disclosed herein, mobile device may refer to any processor-equipped device including, for example, stationary desktop computers. Some embodiments refer to cellular telephone network systems including cell towers of such networks; however, the scope of the present invention and the claims encompass any wired or wireless communication system, including for example, Ethernet, WiFi, WiMax, and other wireless data network communication technologies.

As used herein, the term demographic information and user profile property information are used interchangeably. However, the various embodiments of the invention are directed to inferring various user profile properties which may encompass both traditional and non-traditional demographic information categories.

Short of asking users themselves, demographic information related to users of mobile devices is not readily available. Nevertheless, such demographic information would be very useful to a broad spectrum of applications. In order to obtain such demographic information various embodiment systems and methods are disclosed to infer a user's demographic information based upon the user's behavior and use of their mobile device.

The various embodiments utilize derived information regarding the mobile device usage behavior of a given population of users. The derived information may be derived from information gathered from sources external to the mobile device. For example, statistical information may be obtained by surveying the population of mobile device users regarding a variety of user profile properties as well as a variety of device uses and usage behavioral patterns. Based upon the survey results, classifications for each user profile property category may be developed and probability distributions of a user falling within a particular classification may be derived. These derived probability distributions may then be organized in a series of probability tables. For example, a user population may be categorized by age, income and/or gender, for example. Each user profile property category may in turn have different set of classifications. For example, the gender category has two classifications, i.e., male or female. As further examples, the age-group category and income level category may comprise multiple classifications each representing a range of values (e.g., a 20 to 30 years old classification or $50,000 to $70,000/year annual income classification).

Users' mobile device usage behavior can also be organized into categories and classifications. For example, categories of mobile device usage behavior may include: frequency of sending emails or simple message service (SMS) messages from the mobile device; frequency of twittering (i.e., sending data via twitter.com); frequency of launching a web browser; frequency of launching an audio playing application; frequency of launching a stock market quote application; frequency of participating in social networking groups such as facebook, myspace; and frequency of launching specific websites tagged with the same or similar metadata. Other categories of observed mobile device usage behaviors may include the frequency at which users synchronize their mobile device with another device (e.g., laptop or Bluetooth device), and the frequency of implementing a speakerphone feature during telephone calls. Virtually any function performed by a user on a mobile device may be utilized in the various embodiments as a category of mobile device usage behavior from which a user profile property category may be inferred.

For a given category of user behavior, the behavior may be further grouped into different classifications. Each classification may, for example, indicate different frequencies of occurrence (or levels of interest) of the particular user behavior category.

Information regarding mobile device user usage habits can be obtained from general population surveys that are routinely conducted by a number of consumer research companies. Using information from such surveys of the population of mobile device users, statistical probability distributions can be derived for each user behavior category and for each user profile property category. Such statistics may be expressed in terms of probabilities.

In the various embodiments a mobile device can monitor its user's usage patterns for each of the different categories of user behaviors. The monitored behavior can be analyzed by the mobile device to determine the classification of the user for each type of user behavior. Then, using the population usage statistics and the determined usage classifications of the particular user, the most likely user profile property categories can be inferred using Bayesian statistical analysis.

Bayesian statistical analysis enables assigning a probability to a hypothesis based upon an observed condition and the probability of that condition. According to the Bayesian probability calculus, the probability of a hypothesis given the observed condition (the posterior) is proportional to the product of the likelihood of the hypothesis (often called the likelihood) times the prior probability of the observed condition given the hypothesis (often just called the prior). The likelihood brings in the effect of the observed condition, while the prior specifies the belief in the hypothesis before the condition was observed. More formally, the Bayesian probability calculus makes use of Bayes' formula—a theorem that is valid in all common interpretations of probability. This formula is given in Eq. 1.1 as follows:

$$P ( H \vert D ) = \frac{P ( D \vert H ) P ( H )}{P ( D )} \qquad Eq . 1.1$$

where:

H is a hypothesis, and D is the observed condition (i.e., data);

P(H) is the prior probability of H, i.e., the probability that H is correct before the condition or data D was observed;

P(D|H) is the conditional probability or likelihood of seeing the condition or data D given that the hypothesis H is true;

P(D) is the marginal probability of the observed condition or data D; and

P(H|D) is the posterior probability, i.e., the probability that the hypothesis is true, given the data and the previous state of belief about the hypothesis.

The various embodiments utilize the power of Bayesian statistical analysis by utilizing population surveys to determine the prior probabilities of the various demographic categories and the marginal probability of the observable conditions or data in the population, and then using such statistics to infer the user's profile property category (demographic categories) based on the observed usage behavior data.

As an illustrative example, one may infer a user's age group demographic classification (i.e., hypothesis) based upon the number of SMS messages the user sends in a month (i.e., observed condition) and derived information from a population of users. For purposes of the illustrative example, user profile properties are referred to as demographic information. However, user profile properties other than demographic information may also be inferred using the methods illustrated in the examples. From a variety of external statistical sources, the user population distribution may be derived and mapped into four age groups (for example), which in Table 1 are called A, B, C, and D. The probability distribution of these age-groups (prior probability) may be derived from consumer survey results which yield the percentage of the population of mobile device users within each age group. Such statistical information may be obtained from commercial sources, such as MMetrics®, or by conducting dedicated surveys. For the purpose of this example, the various mobile user age group probability distribution (P(AgeGroup)) may be derived from the MMetric statistics. These derived probability distributions are listed in Table 1. In this example, within the total population of mobile device users, 20% are 13-24 years old, 37% are 25-44 years old, 17% are 45-54 years old and 25% are 55 years old or older. Thus, the probability that a user of a mobile device is between the ages of 25 and 44 is 37%, while the probability that a user of mobile device is between the ages of 45 and 54 is 17%. Knowing this simple statistical information, a crude inference may be made regarding the relative age of the user of a mobile device. Based upon the user age distribution alone, one might infer that the user of a mobile device is most likely a member of age-group B since it is the demographic category classification with the highest probability. However, this inference would be wrong more than 60% of the time.

TABLE 1
AgeGroups and p(AgeGroup)

| | A | B | C | D |
|---|---|---|---|---|
| AgeGroups | 13-24 | 25-44 | 45-54 | 55+ |
| P(AgeGroup) | 0.20 | 0.37 | 0.17 | 0.25 |

The various embodiments apply Bayesian principles of conditional probability to refine inferences regarding the user's demographic information based on the user's mobile device usage behavior. For example, by knowing some statistical information regarding the SMS habits of users in each of the age groups (observed conditions) as well as the derived probability distribution of the age-groups (prior probability), a refined inference may be made. For this example, users may be classified into groups based on the frequency at which users send SMS messages, such as: group S0-Never sends an SMS; group S1-Sends SMS Daily; group S2-Sends SMS Weekly; and group S3-Sends SMS Monthly.

By conducting surveys of the population of mobile device users to obtain data regarding each user's age and SMS texting frequency, a table of conditional probabilities P(S0|A), P(S1|A), P(S3|C) etc. may be derived such as shown in Table 2 below. These conditional probabilities reflect the percentage of users in each age group that send SMS messages in each of the groups. For example referring to column A, among users aged 13-24, 24.3% never send SMS messages (group S0), 51.6% send SMS messages daily (group S1), 13.9% send SMS messages weekly (group S2), and 10.2% send text messages monthly (group S3). As expected the probabilities in every column add up to 1 as the probabilities reflect the SMS usage groups within a particular age group.

TABLE 2
Conditional Probabilities for SMS Classification given AgeGroup

| | A | B | C | D |
|---|---|---|---|---|
| P(S0\|AgeGroup) | 0.2430 | 0.3998 | 0.5988 | 0.8440 |
| P(S1\|AgeGroup) | 0.5157 | 0.2845 | 0.1330 | 0.0353 |
| P(S2\|AgeGroup) | 0.1393 | 0.1653 | 0.1256 | 0.0454 |
| P(S3\|AgeGroup) | 0.1020 | 0.1504 | 0.1427 | 0.0753 |

This conditional probability table then can be used to infer the age group of a user by determining the particular SMS usage group of the user. For example referring to Table 2, the probability that a user who never sends an SMS message (i.e., observed SMS usage group S0) is in age group D (55+) is 84.4%. In contrast, the probability that a user who never sends an SMS message is in age group A (13-24) is only 24.3%. Thus, by applying Bayesian probability principles, one may infer the posterior probability of a user's age group based upon the observed condition of their SMS message frequency (i.e., P(Age Group|SMS Class)). This calculation may be represented by the equation 1.2 which shows that P(Age Group|SMS Class) is proportional to the probability of an age group times the probability of a SMS class given the age group.

P(AgeGroup|SMSClass)˜P(AgeGroup)*P(SMSClass|AgeGroup) Eq. 1.2

Note that the marginal probability of each SMS group is ignored, so the factor of 1/P(D) (i.e., 1/P(SMSClass) in this example) from equation 1.1 is not included on the right hand side of equation 1.2. This factor is needed to calculate the probability of a particular age group given an observed SMS behavior group. However, as shown below, the most likely age group can be inferred based upon the age group which has the highest value in equation 1.2. This inference is useful in many applications where only the most likely group needs to be determined, not the actually probability of that most likely group.

Equation 1.2 can be used to infer the most likely user age group based on the observed usage behavior (the observed condition). For example, by observing that a user has sent no SMS messages over a period of time, the mobile device can classify its user in the S0 SMS class. Equation 1.2 may then be applied with reference to probability Tables 1 and 2 to obtain each of P(AgeGroup) and P(SMSClass|AgeGroup). By multiplying the conditional probability of a user never sending an SMS message (i.e., SMS class S0) for age group A (0.2430) by the probability that the user falls within that age group A (0.20) yields a value representative of the likelihood that a user with such SMS usage behavior is between the ages of 13 and 24 (Age Group A). In the instant example that value is estimated at 0.0486. Performing the same calculation for each of the age groups yields values of 0.148 that the same user is between the ages of 25-44 (Age Group B), a value of 0.101796 that the same user is between the ages of 45-54 (Age Group C), and a value of 0.211 that the same user is 55+ (Age Group D). Note that, per equation 1.1, to determine the true Bayesian probabilities of each age group these values have to be divided by P(SMSClass) (i.e., the marginal probability). Since the marginal probability is not dependent upon the age group, (i.e., P(SMSClass) is the same for each age group) for the sake of determining which age group is most likely the variable 1/P(SMSClass) can be treated as a scaling factor that can be ignored.

Completing the calculations for all SMS usage groups results in the inference table shown in Table 3 below. It is noted that each of the values in Table 3 are a proportional value reflecting the relative likelihood of each age group and SMS usage group, and are not the actual Bayesian probabilities. In order to calculate the Bayesian probabilities each value would have to be divided by the marginal probability of the respective SMS usage groups (the observed condition). Consequently, the values of the entries in the table do not add up to 1 in either rows or columns. Nevertheless, since the marginal probability is the same for each row in the table, the values in each row are proportional to the likelihood for each hypothesis (age group) given the observed condition (SMS usage group).

Since the values shown in Table 3 are proportional to the likelihood of each age group given the observed SMS usage group, the most likely age group can be determined by looking across each SMS usage group row to determine the age group with the highest value of the product of P(AgeGroup) and P(SMSClass|AgeGroup). This is shown in the rightmost column titled “Winning Age Group” which lists the most likely age group classification as the age group with the highest product of P(AgeGroup) and P(SMSClass|AgeGroup). For example, the most likely age group of a user who never sends an SMS message (i.e., SMS group S0) is the 55+ age group D.

TABLE 3
Product of P(AgeGroup) and P(SMSClass|AgeGroup)

| | | | | | Winning |
|---|---|---|---|---|---|
| SMSClass | A | B | C | D | AgeGroup |
| S0 | 0.0486 | 0.1479 | 0.1018 | 0.2110 | D |
| S1 | 0.1031 | 0.1052 | 0.0226 | 0.0088 | A |
| S2 | 0.0278 | 0.0612 | 0.0214 | 0.0114 | B |
| S3 | 0.0204 | 0.0557 | 0.0243 | 0.0188 | B |

Thus, by observing a single behavior trait of the mobile device user, a higher confidence inference about the user can be obtained.

The ability to infer the user's demographic information may be useful in a number of applications. As an example, a company may conduct directed marketing by sending mass SMS messages advertising their product to all mobile device users (e.g., cell phones) in a region. In order to appeal to the widest audience, the SMS messages may contain content that is most appealing to the 25-44 age group. This particular demographic group may be chosen because it encompasses the highest share of all mobile device users (i.e., 37%, see Table 1). However, for more than 60% of the recipients the content of the SMS message would be inappropriate or of minimal relevance. Thus, the advertising SMS messages would be ineffective more than half the time and might be viewed as being a nuisance. To improve the effectiveness of such a direct marketing effort, filters may be implemented on a user's mobile device, which prevent such inappropriate content from being displayed. Such filters could ask the user to provide his/her demographic information. By implementing the various embodiments described herein, a mobile device may infer the user's demographic information automatically based upon the user's behavior in mobile device usage. As a result the effectiveness of such filters can be improved without requiring cooperation of the user.

As another example, inferring the user's age group may be used to automatically modify the font size of the mobile device display or volume of the speaker to best suit the user.

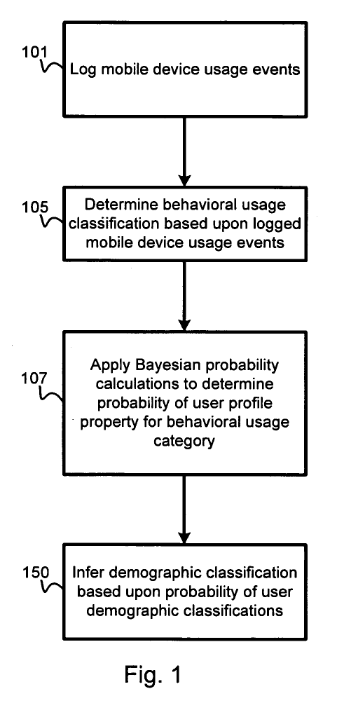

FIG. 1 is a process flow diagram of an embodiment method for inferring demographic information of users given observed data regarding their mobile device usage. As users go about their daily routines, various mobile device usage events may be logged by the mobile device processor in a mobile device memory, step 101. As discussed above, a specific mobile device usage event may be any of a wide variety of actions or settings, such as, for example, the transmission of an SMS message by a user. In this example, the usage behavior category (observed data) determined by the mobile device processor would be the frequency of sending SMS messages such as described above. Each time the user composes, replies to, or forwards an SMS message, that event may be recorded in a log stored in memory. Once the log is created (e.g., after several events are recorded), a determination can be made as to which classification for the specified usage behavior category the user should be classified in based on the logged usage events, step 105. Once the user's usage behavior is classified, the relative likelihood value (e.g., Eq. 1.2) may be calculated to obtain the various relative likelihood values for each demographic category (e.g., age-group) for the determined usage behavior classification, step 107. Having calculated the relative likelihood values for all demographic categories (e.g., age-groups) for the determined usage behavior classification, the user's demographic category may be inferred by determining the demographic category with the highest relative likelihood value, step 150. Once the demographic classification has been inferred it may be used by a host of applications.

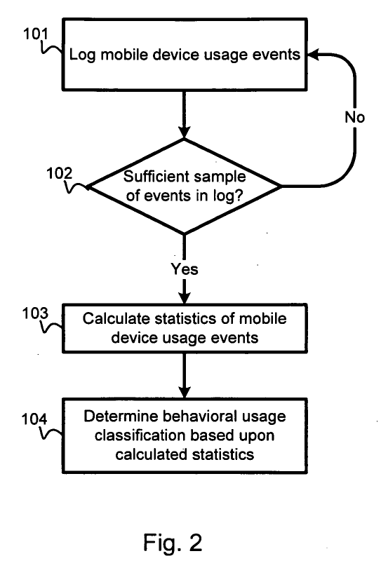

FIG. 2 is a process flow diagram detailing an embodiment method for determining the usage behavior classification based on a user's mobile device usage. Referring to FIG. 2, a mobile device processor may log specific mobile device usage events in a mobile device memory, step 101. As described above, the specified mobile device usage events may be any one or combination of the various functions or operations performed on or by a mobile device. When an event occurs the mobile device processor may be alerted to it and insure that its occurrence is properly logged. For many behavior categories a sufficiently sized data sample will be required before an accurate behavior category classification determination may be made. For example, if the behavior category is frequency of sending SMS messages, monitoring and logging a user's behavior pattern of sending SMS messages may be required over a sufficiently long period of time to generate an accurate determination of usage behavior classification. However, the information stored in the log will depend upon the nature of the event classification used. For example, if the usage classification is based upon frequency within a calendar period, the log may simply be a count that is incremented with each event. For example, SMS usage behavior classification may be: S0-Never sends an SMS, S1-Sends SMS Daily, S2-Sends SMS Weekly, S3-Sends SMS Monthly. Thus, to classify the user in one of these usage behavior classifications, a count of the user's SMS message transmissions may be logged for at least a month before an accurate classification may be made.

As events are logged in the mobile device memory the processor may periodically determine whether a sufficient sample of event data has been logged to make an accurate usage behavior classification determination, decision 102. For example, the sufficient sample determination may depend upon whether a certain number of events have been logged. Alternatively, the sufficient sample determination may be made after a pre-determined period of time has elapsed. Other criteria for determining when a sufficient sample of events has been logged may be implemented. If a sufficient sample of events has not been logged (i.e., decision 102=No), the mobile device processor may continue to log events, returning to step 101. In an alternative embodiment, the mobile device processor may extrapolate log results based on existing event log results until a sufficient sample of events has been logged. If a sufficient number of events have been logged (i.e., decision 102=Yes), the mobile device processor may proceed to determine the appropriate usage behavior classification for the user.

Some usage behavior classification may not be easily quantifiable. Consequently, additional statistical analysis may be necessary to accurately determine a user's appropriate usage behavior classification. Referring to the illustrative example in which usage behavior classifications include S0-Never sends an SMS, S1-Sends SMS Daily, S2-Sends SMS Weekly, and S3-Sends SMS Monthly a user that sends an SMS message on one day could be classified as an S1, an S2 and S3 on that particular day. To distinguish between these categories, events must be logged over at least a month's worth of time to determine whether messages are sent every day, and if not, whether messages are sent at least weekly. By calculating the statistics of the monitored usage events, step 103, a more accurate determination of the usage behavior classification may be made, step 104.

The example discussed above illustrates how Bayesian probability principles may be used to infer user demographic information given information regarding a single observed conditional event. By increasing the number of observed conditional events, the accuracy of the inference may be further refined.

A second illustrative example usage behavior category may be the frequency of launching an MP3 player application. For example, the classification groups for this usage behavior category may be: group M0-Never uses an MP3 application, group M1-Uses an MP3 application Daily, group M2-Uses an MP3 application Weekly, group M3-Uses an MP3 application Monthly. As discussed above surveys of the population of mobile device users can also obtain data regarding each user's MP3 player usage frequency. Using this survey information, a table of conditional probabilities P(M0|A), P(M1|A), P(M3|C), etc., may be derived and arranged in a probability table such as shown in Table 4 below. These example conditional probabilities reflect the percentage of users in each age group that use an MP3 player application in each of the respective MP3 usage behavior groups. For example, column A of Table 4 shows the probability that a user never uses the MP3 player application given if the user is aged 13-24 is 84.3%; the probability that a user uses the MP3 player application daily given that the user is aged 13-24 is 4.45%; the probability that a user uses the MP3 player application weekly given that the user is aged 13-24 is 4.74%; and the probability that a user uses the MP3 player application monthly given that the user is aged 13-24 is 6.56%. As expected, the probabilities in every column add up to 1 as the probabilities reflect the distribution of usage of the MP3 player application within a particular age group.

TABLE 4
Conditional Probabilities for MP3 usage given AgeGroup

| | A | B | C | D |
|---|---|---|---|---|
| P(M0\|AgeGroup) | 0.8425 | 0.9183 | 0.9678 | 0.9915 |
| P(M1\|AgeGroup) | 0.0445 | 0.0188 | 0.0051 | 0.0011 |
| P(M2\|AgeGroup) | 0.0474 | 0.0245 | 0.0102 | 0.0030 |
| P(M3\|AgeGroup) | 0.0656 | 0.0384 | 0.0169 | 0.0043 |

Knowing that the distribution of users within the age groups, the class of SMS usage behavior of a user, and the class of MP3 player usage (P(A&S&M) is equal to the probability of a user being in a particular age group given a particular SMS classification and MP3 classification (P(A|S&M)) multiplied by the probability of a user being in a particular class of SMS usage and class of MP3 player usage (P(S&M)) as shown in Equation 2.1.

P(A&S&M)=P(A|(S&M))*P(S&M) Eq. 2.1

Further, it is known that the probability of a user being in a particular age group, class of SMS usage, and class of MP3 player usage (P(A&S&M) is also equal to the probability of a user being in a particular age group (P(A)) multiplied by the probability of a user being in a particular SMS Classification and MP3 Classification given an age group (P((S&M)|A)) multiplied by the probability of a user being in a particular class of SMS usage and class of MP3 player usage (P(S&M)) as shown in Equation 2.2.

P(A&S&M)=P(A)*P((S&M)|A) Eq. 2.2

Thus

P(A&S&M)=P(A|(S&M))*P(S&M)=P(A) *P((S&M)|A) Eq.2.3

A variable K may be substituted for the probability of a user being in a particular SMS Classification and MP3 Classification as shown in Equation 2.4.

K=P(S&M) Eq. 2.4

Then,

P(A|(S&M))*K=P(A)*P((S&M)|A). Eq. 2.5

Therefore,

P(A|(S&M))=(1/K)*P(A)*P((S&M)|A). Eq. 2.6

Assuming naive Bayesian independence, one can assume that

P((S&M)|A)=P(S|A)*P(M|A). Eq. 2.7

Therefore,

P(A|(S&M))=(1/K)*P(A)*P(S|A)*P(M|A). Eq. 2.8

As discussed above, surveys of mobile device users can be used to obtain external statistics regarding the conditional probability of a single usage behavior classification given a demographic classification. Therefore, a Bayesian probability calculation of a demographic classification given a combination of observed behaviors may be calculated using such available conditional probability statistics and equation 2.8.

As described above, for each possible usage behavior classification combination the probability of that combination will be the same across all age groups. As such, that probability value can be treated simply as a scaling factor. Therefore, the value of K in the equation 2.8 may be ignored and a relative likelihood value (RLV) for each possible age-group across a given usage behavior classification combination may be calculated. To infer which age group would be the most likely given a usage behavior classification combination one may select the Age Group that maximizes P (A|(S&M)) or the age group that maximizes the product

RLV=P(A)*P(S|A)*P(M|A) Eq. 2.10

Just as the second example illustrates how a demographic classification of the user may be inferred given information regarding two categories of events, alternative embodiments can infer a user's demographic classification given usage information regarding a plurality of usage event categories.

As discussed above, known conditional probability distributions among different classes of specific demographic category values may be available from external mobile user population statistics suppliers for a variety of behavior categories and demographic categories. Using such statistics relative likelihood values of a particular demographic category classification may be calculated given various combinations of observed behavior classifications combinations.

To show how this inference can be calculated assume that the conditional probabilities for the category related to specific types of user behavior categories (Type1, Type2, . . . TypeK) are available for each class for the demographic category (also referred to as User Profile Property (UPP)). Thus, conditional probability values for P(Type1Class|UPPClassI), p(Type2Class|UPPClassI) . . . P(TypeKClass|UPPClassI) are available through surveys or external third party providers. Joint conditional probabilities may also be available across certain user behavior types such as a probability P((TypeXClass ∩ TypeYClass ∩ . . . TypeZClass)|UPPClassI) across user behavior types TypeX, TypeY, and TypeZ. Such joint conditional probabilities will be preferred over using the respective conditional probabilities for each user behavior type when they are available. Subsequently, a UPPClass Inference Table can be derived by computing the Bayesian relative likelihood values for classes I for the UPP and the different classification for each user behavior category as the product:

P(UPPClassI)*P((Type1Class ∩ Type2Class ∩ . . . TypeJClass)|UPPClassI).

The winning UPP class for a given combination of user behavior categories is given by determining the UPP class that maximizes the above product, i.e., by computing the product:

Max(P(UPPClassI)*P((Type1Class ∩ Type2Class ∩ . . . TypeJClass)|UPPClassI)).

When joint conditional probabilities are not available, a naive-Bayesian estimate can be used by taking the product of the respective conditional probabilities for the user behavior type categories given the UPPClassI.

In the extreme case, one can assume that type categories are all conditionally independent, so that the product in equation 3.3 reduces to computing the product,

$$p ( UPPClassI ) {\prod }_{j = 1}^{K} p ( TypeJCategory / UPPClassI ) .$$

The winning UPP class for a given set of user behavior categories is then given by determining the UPP class that maximizes the above product, i.e. by computing:

$${Max}_{I} ( p ( UPPClassI ) {\prod }_{j = 1}^{K} p ( TypeJCategory / UPPClassI ) ) .$$

The winning user profile property class for each combination of user behavior type categories can be stored in an enumerated table (see e.g. Table 5 below) for the different choices for the user behavior type as described in more detail below.

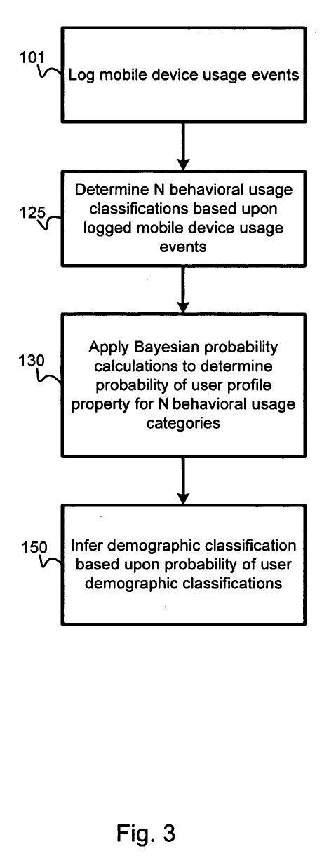

FIG. 3 is a process flow diagram of an embodiment method for inferring user profile properties based on the user's usage behavior within a plurality of usage behavior categories. As users go about their daily routines, various mobile device usage events may be logged by the mobile device processor in a mobile device memory, step 101. As discussed above, a specific mobile device usage event may be any of a wide variety of actions or settings, such as, for example, the transmission of SMS messages by a user and/or the frequency at which a user uses an MP3 player application. In this example, each time the user composes, replies to, or forwards an SMS message, or launches an MP3 player application, that event may be recorded in a log stored in memory. Once the log is created (e.g., after several events are recorded), a determination can be made as to which classification for N number of specified usage behavior categories into which user should be classified based on the logged usage events, step 125. Once the user's usage behavior category for each of N usage behavior categories is determined, the relative likelihood values may be calculated given N usage behavior classifications (observe conditions), step 130. Having calculated the various relative likelihood values, a user profile property classification may be inferred by determining the user profile property category classification with the highest relative likelihood value, step 150. Once the user profile property category classification has been inferred it may be used by a host of applications.

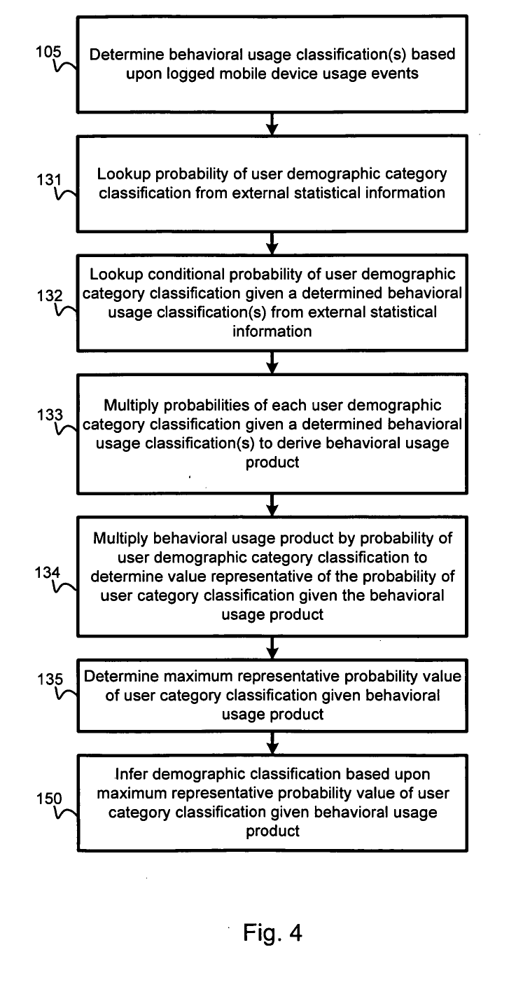

FIG. 4 is a process flow diagram of an embodiment method for inferring a user profile property (step 150) by calculating the relative likelihood values based on the user's classification within a plurality of usage behavior categories. Based upon the log of mobile device usage events, the various usage behavior classifications may be determined, step 105. As discussed above with respect to FIG. 2, this step may require a sufficient number of logged events to enable an accurate determination of a usage behavior classification. In addition, this step may further require a statistical analysis to determine the most appropriate usage behavior classification.

Using external statistical information (e.g., Table 1) the probability of a user falling into one of the user demographic category classifications may be looked up, step 131. For example, as discussed above, Table 1 may be derived from survey results to provide external statistical information regarding the probability that a user's age (demographic category) falls within one of four Age Groups (demographic category classification) A, B, C, or D. Using other derived statistical information (e.g., Tables 2 and 4) the conditional probabilities of a user falling into one of a plurality of usage behavior category classifications given a user demographic category classification may be retrieved, step 132. For example, Table 2 provides externally derived statistical information regarding the conditional probability that a user falls within a SMS usage classification (first usage behavior classification) given the user's age group (demographic category classification). Similarly, Table 4 provides externally derived statistical information regarding the conditional probability that a user falls within an MP3 player application usage classification (second usage behavior classification) given the user's age group.

By classifying the user's behavior into various usage behavior category classifications, a combination of usage behavior classifications may be determined. With the various externally derived probabilities and conditional probability values known, a usage behavior product may be calculated by multiplying the conditional probabilities for each possible usage behavior category classification given the demographic category classification by one another, step 133. Referring to the illustrative example, a first possible conditional probability combination could be that the user's mobile device usage behavior merits a classification as a combined group S0, M0 (i.e., never uses SMS or MP3). Multiplying the conditional probability for each usage behavior classification given the demographic category classification by each other results in a usage behavior product of 0.2430 (from Table 2, (P(S0|AgeGroup) for Age Group A)*0.8425 (from Table 4, (P(M0|AgeGroup) for Age Group A)=0.2047 for the first conditional probability combination (S0, M0) given Age Group A.

The usage behavior product is then multiplied by the probability of the user falling within the user demographic category classification to determine the relative likelihood value of the user category classification given the usage behavior classification combination, step 134. Referring to the illustrative example, the usage behavior product for the first conditional probability combination S0, M0 given Age Group A (0.2047) is multiplied by the probability that a user of a mobile device falls within Age Group A (from Table 1 is 0.20) to produce a relative likelihood value of the user category classification (Age Group A) given the usage behavior classification combination (S0, M0). Performing the calculation yields:

(P(S0/AgeGroupA)*(P(M0/AgeGroupA)=0.04094.

Again, to calculate the actual Bayesian probability one must divide the relative likelihood value by the marginal probability that the user's mobile device usage would result in the user being classified as (S0, P0) (i.e., P(S0&P0, also referred to as scaling factor K). By performing this calculation for each user category classification (Age Group A-D), the relative likelihood value for each demographic category classification given the usage behavior classification combination may be obtained. By identifying the maximum relative likelihood value, step 135, the most likely user category classification may be inferred for the determined usage behavior classification combination, step 150. Once the demographic classification has been inferred it may be used by a host of applications.

Calculating the relative likelihood value for each user category classification given the usage behavior combination (S0, M0) in the illustrative example, results in values of 0.04094 for Age Group A, 0.1358 for Age Group B, 0.0985 for Age Group C, and 0.2092 for Age Group D. Since the maximum relative likelihood value is 0.2092, Age Group D is inferred to be the most likely demographic category classification (Age Group) if a user never sends an SMS and never uses the MP3 application.

In a similar manner as described above to generate Table 3, an inference table may be generated which stores the relative likelihood value for each possible usage behavior classification combination as illustrated in Table 5. In Table 5 the rightmost column titled “Winning Age Group” lists the most likely age group classification (i.e., the age group with the highest relative likelihood value for each behavior classification combination).

TABLE 5
P (AgeGroup) * P (SMSClass|AgeGroup) * P (MP3Class|AgeGroup)

| | | | | | | Winning |
|---|---|---|---|---|---|---|
| SMSClass | MP3Class | A | B | C | D | AgeGroup |
| S0 | M0 | 0.0417 | 0.1362 | 0.1006 | 0.2106 | D |
| S1 | M0 | 0.0885 | 0.0969 | 0.0223 | 0.0088 | B, A |
| S2 | M0 | 0.0239 | 0.0563 | 0.0211 | 0.0113 | B |
| S3 | M0 | 0.0175 | 0.0513 | 0.0240 | 0.0188 | B |
| S0 | M1 | 0.0022 | 0.0028 | 0.0005 | 0.0002 | B |
| S1 | M1 | 0.0047 | 0.0020 | 0.0001 | 0.0000 | A |
| S2 | M1 | 0.0013 | 0.0012 | 0.0001 | 0.0000 | A |
| S3 | M1 | 0.0009 | 0.0011 | 0.0001 | 0.0000 | B |
| S0 | M2 | 0.0023 | 0.0036 | 0.0011 | 0.0006 | A |
| S1 | M2 | 0.0050 | 0.0026 | 0.0002 | 0.0000 | A |
| S2 | M2 | 0.0013 | 0.0015 | 0.0002 | 0.0000 | B |
| S3 | M2 | 0.0010 | 0.0014 | 0.0003 | 0.0001 | B |
| S0 | M3 | 0.0032 | 0.0057 | 0.0018 | 0.0009 | B |
| S1 | M3 | 0.0069 | 0.0040 | 0.0004 | 0.0000 | A |
| S2 | M3 | 0.0019 | 0.0024 | 0.0004 | 0.0000 | B |
| S3 | M3 | 0.0014 | 0.0021 | 0.0004 | 0.0001 | B |

Based on the outcome of the winning category from Table 5, the following simplified inference table (Table 6) may also be externally derived. In this table the most probable age group (winning age group) is inferred based on the observed SMS Classification and MP3 Classification. If the relative likelihood values of other age groups are desired based on the observations, then the probabilities in Table 5 along a row for the given observations can be used.

TABLE 6
Simplified Age Group Inference Table based on
Mobile Device Observations

| | M0 | M1 | M2 | M3 |
|---|---|---|---|---|
| S0 | D | B | A | B |
| S1 | B, A | A | A | A |
| S2 | B | A | B | B |
| S3 | B | B | B | B |

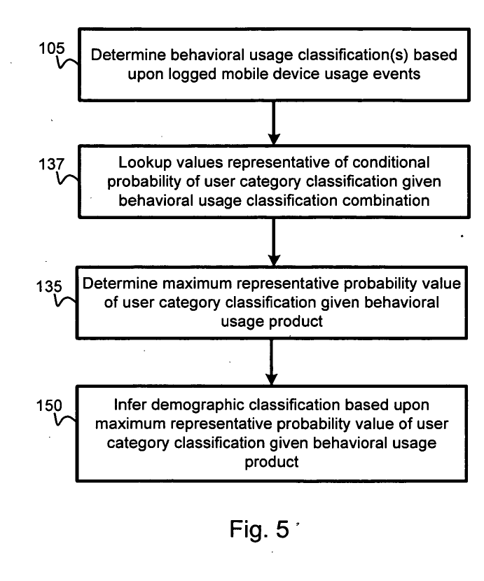

Once the Tables 3, 5 and 6 are generated, a mobile device can use the tables to infer a demographic category classification of its user simply by observing (i.e., logging) various events performed on the mobile device by the user. FIG. 5 is a process flow diagram of an alternative method for inferring a user's demographic information by performing a table look up of the most likely demographic classification that a user falls into. This alternative embodiment takes advantage of the calculations described above to generate an inference table (e.g., Tables 3 or 5) that can be used to quickly look up a likely user category classification given a combination of usage behavior classifications. As above, a mobile device processor may determine the appropriate usage behavior classification(s) based upon logged mobile device usage events, step 105. Once the usage behavior classifications are determined, the relative likelihood values for each user category classification given a usage behavior classification combination may be looked up within an inference table (e.g., Table 5), step 137. By identifying the maximum relative likelihood value for the usage behavior classification combination in the inference table, step 135, the most likely user category classification may be inferred given the usage behavior classification combination, step 150. Once the demographic classification has been inferred it may be used by a host of applications.

In another alternative embodiment, use is made of a simplified inference table (e.g., Table 6). This alternative embodiment makes use of the calculations described above to generate a simplified inference table (e.g., Table 6) that can be used to quickly look up a likely user category classification given a usage behavior classification combination. As described above, a mobile device processor may determine the appropriate usage behavior classification(s) based upon logged mobile device usage events, step 105. Once the usage behavior classification(s) are made, the most likely user category classification may be looked up in the simplified inference table for the usage behavior classification combination, step 150. Once the demographic classification has been inferred, it may be used by a host of applications to control various preferences or settings on the mobile device. The alternative embodiment shown in FIG. 5 has the advantage of providing the relative likelihood values of user category classifications given the usage behavior classification combination.

The alternative embodiments employing table look up methods may conserve processing power of the mobile device by foregoing the need to perform the various calculations described above with reference to FIG. 4. However, as the number observed usage behavior categories increases and as the granularity of the groupings in the behavior category classifications and demographic category classifications increases the size of the looked up inference tables (e.g., Tables 3 and 5) may become prohibitively large for the limited storage capabilities of mobile devices. This is because as the number of observed behavior categories used to infer a demographic classification increases, the number of possible demographic category classifications increase, and/or as the number of possible usage behavior category classifications increase, the size of the inference table increases exponentially. On the other hand, the more usage behavior categories used, i.e., the number of possible observed condition combinations, the more reliable will be the user demographic inferences that may be drawn. Therefore, it may be more efficient and effective to store a plurality of relatively small sized probability and conditional probability tables for each demographic category and demographic category (e.g., Tables 1, 2, 4) and perform the relatively simple mathematical multiplication operations described above to calculate the relative likelihood values and then determine the maximum. These calculations can be performed relatively quickly by a mobile device processor and eliminates a need to store large inference tables.

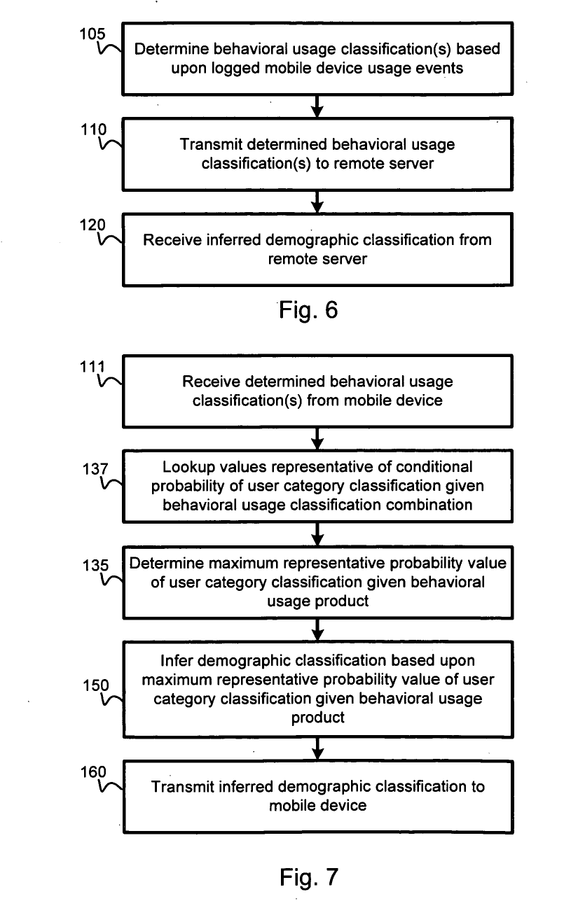

FIG. 6 is a process flow diagram of an alternative method performed by a user's mobile device for deriving a user's demographic information using a remote server. The embodiment enables use of inference tables that are larger than can be stored in a mobile device memory. Instead of performing a table look up within the mobile device memory, a mobile device may transmit information regarding the user's usage behavior to a remote server where the table look up can be performed. The remote server processor may use the received information to look up the most likely user demographic category classification using either a stored inference table (e.g., Tables 3, 5) or a simplified inference table (e.g., Table 6). Once the server infers the user's demographic classification, this information can be transmitted back to the mobile device. Referring to FIG. 6, based upon the log of specified mobile device events, the various usage behavior classifications may be determined by the mobile device processor, step 105. As discussed above with reference to FIG. 2, this step may require that a sufficient number of events be logged to make an accurate determination of a usage behavior classification. In addition, this step may further require a statistical analysis to accurately determine the most appropriate usage behavior classification. The determined usage behavior classification(s) are then transmitted via a communication network to a remote server, step 110. The communication network may be any of a variety of communication networks. For example, the communication network may be a wireless cellular communication network. The communication network may be the Internet which may comprise wired and/or wireless network connections. Other communication networks including local area, wide area, near field, and any other communication networks may be used. The determined usage behavior classification(s) may be used by the remote server to infer the demographic category classification as described below with reference to FIG. 7. The inferred demographic category classification may then be transmitted from the remote server back to and received by the mobile device, step 120. Once the inferred demographic classification has been received by the mobile device, it may be used by a host of applications running on the mobile device to control various preferences and settings.

FIG. 7 is a process flow diagram of an alternative method that may be performed by a remote server to infer a user's demographic information based upon the user's mobile device usage. The remote server may receive determined usage behavior classification(s) from a mobile device via a communication network, step 111. Once received, the remote server processor may use the usage behavior classification(s) to look up the relative likelihood values of each user category classification given a received usage behavior classification combination using an inference table (e.g., Table 5), step 137. By identifying the maximum relative likelihood value for the usage behavior classification combination on the inference table, step 135, the most likely user demographic category classification may be inferred given the usage behavior classification combination, step 150. Once the inferred demographic classification has been determined by the remote server processor, the demographic classification may be transmitted to the mobile device via the communication network, step 160. Once received by the mobile device, the demographic classification may be used by a host of applications running on the mobile device to control various preferences and settings.

In an alternative embodiment, the mobile device may transmit raw mobile device usage log data to a server to enable the remote server processor to perform the steps necessary to determine the various usage behavior classification(s). By offloading this operation to the remote server, limited processing powers of the mobile device may be conserved. Once the raw mobile device usage log data is received by the remote server, the remote server processor may infer the user's demographic classification using any of the alternative embodiments disclosed herein. The inferred demographic classification may then be transmitted back to the mobile device. It should be noted, however, that users may wish to keep their mobile device usage events private. As such, embodiments sending and receiving data regarding the user's behavior may not be favored. User privacy concerns may be alleviated by encrypting log data or by only transmitting generalizing usage behavior classification codes.

In another alternative embodiment, the remote server may perform steps 137, 135 and 150 using a simplified inference table (see e.g., Table 6) stored in the server memory and transmitting the inferred demographic classification information to the mobile device. In still another alternative embodiment, the remote server may implement the steps discussed above with reference to FIG. 4 to calculate probabilities or relative likelihood values of demographic classifications given certain usage behavior classification combinations. Such an alternative embodiment offloads some of the processing tasks from the mobile device to the remote server and takes advantage of the increased memory contained in the remote server which may accommodate large inference tables (e.g., Table 5) which are too large to store on a mobile device.

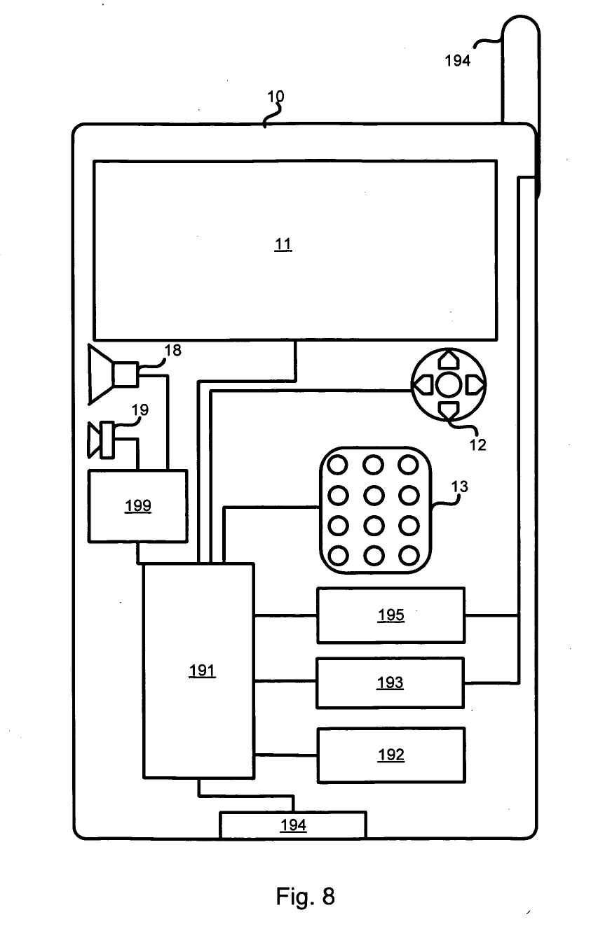

The embodiments described above may be implemented on any of a variety of mobile devices, such as, for example, cellular telephones, personal data assistants (PDA) with cellular telephone and/or WIFI transceivers, mobile electronic mail receivers, mobile web access devices, laptop computers, palmtop computers and other processor-equipped devices. In addition, the various embodiments disclosed herein may be implemented by any processor-equipped device including stationary desktop computers. Typically, such portable computing devices will have in common the components illustrated in FIG. 8. For example, the mobile device 10 may include a processor 191 coupled to internal memory 192 and a display 11. Additionally, the mobile device 120 may have an antenna 194 for sending and receiving electromagnetic radiation that is connected to a wireless data link and/or cellular telephone transceiver 195 coupled to the processor 191. In some implementations, the transceiver 195 and portions of the processor 191 and memory 192 used for cellular telephone communications is referred to as the air interface since it provides a data interface via a wireless data link. Mobile devices 10 also typically include a key pad 13 or miniature keyboard and menu selection buttons or rocker switches 12 for receiving user inputs. The processor 191 may further be connected to a vocoder 199 which is in turn connected to a microphone 19 and speaker 18. The mobile device may also include a GPS receiver circuit 193 which is configured to receive signals from GPS satellites to determine the precise global position of the mobile device 10. The mobile device 10 may also include a wired network interface 194, such as a universal serial bus (USB) or FireWire® connector socket, for connecting the processor 191 to an external computing device such as a personal computer or external local area network.

The processor 191 may be any programmable microprocessor, microcomputer or multiple processor chip or chips that can be configured by software instructions (applications) to perform a variety of functions, including the functions of the various embodiments described above. In some mobile devices 10, multiple processors 191 may be provided, such as one processor dedicated to wireless communication functions and one processor dedicated to running other applications. Typically, software applications may be stored in the internal memory 192 before they are accessed and loaded into the processor 191. In some mobile devices 10, the processor 191 may include internal memory sufficient to store the application software instructions. For the purposes of this description, the term memory refers to all memory accessible by the processor 191, including internal memory 192 and memory within the processor 191 itself. In many mobile devices 10, the memory 192 may be a volatile or nonvolatile memory, such as flash memory, or a mixture of both.

As described above, any of a number of user usage patterns or behaviors may be observed and used to infer a demographic category classification of the user. A number of observed behaviors may include the frequency at which the user launches or uses various software applications on the mobile device. Other user behaviors may also be observed and used to infer a demographic category classification. For example, monitoring the location of the user's mobile device using information from a GPS receiver unit 193, as well as the frequency that the user visits particular locations may provide information that can also be used to infer a user's demographic information. For example, the probability distribution of the gender, income level, and/or age of attendees at a particular sports facility may be obtained through a survey of attendees. Similar to the conditional probabilities shown in Tables 2 and 4, a table of conditional probabilities of frequency of attendance given gender may be generated and used as one of the behavior category classifications in the embodiments disclosed herein. Similarly, other user behavior patterns may be observed and used to infer a demographic classification. As another example, the frequency that a user connects the mobile device 10 to another device via a wired network interface 194 may be logged. Another observed user behaviors may be the frequency that the user synchs the mobile device 10 with another device via a near/local field wireless transceiver within the mobile device 10 (not shown) such as Bluetooth®, Zigbee® or similar protocol transceiver. Another observed behavior may be the frequency that the user recharges the battery of the mobile device 10 or the frequency that the user recharges the battery of the mobile device 10 in a car. So long as external statistics are available for the observed behavior to generate the necessary conditional probability values, those observed behaviors may be utilized by the various embodiments.

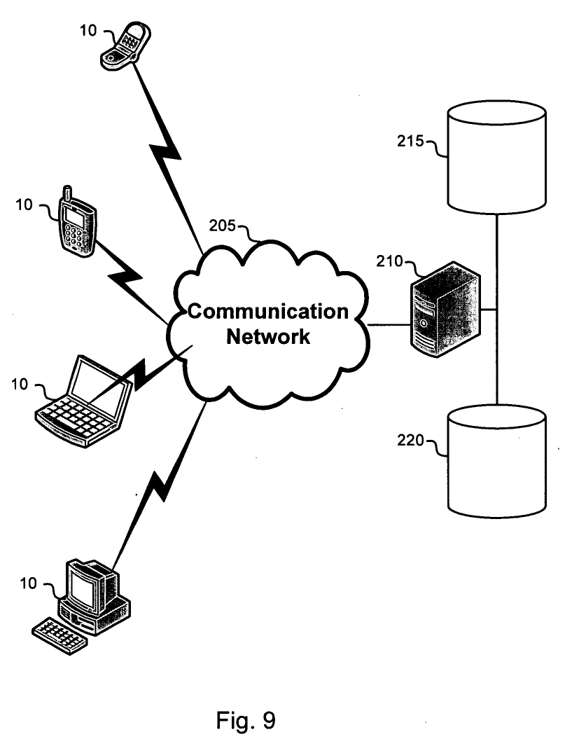

Various embodiments described above may be used in a communication system which links mobile devices 10 to a remote server via a communication network. FIG. 9 illustrates a communication system upon which the various embodiments may operate. As shown in FIG. 9, a plurality of mobile devices 10 may be in communication with a remote server 210 via a communication network 205. Each of the mobile devices 10 may communicate with the remote server 210 via a communication network 205. The communication network may be the Internet, a private or public, wired or wireless, local or wide or near field area communication network, or any combination thereof. The remote server 210 may optionally be connected to external database units 215, 220 which may store external statistical information, externally or internally calculated inference tables, or other information. In some embodiments, statistical information regarding users and their respective behaviors may be surveyed and sampled (with proper authorization) to generate internal statistical information regarding user populations and their behavior patterns. Such statistical information may be obtained by a remote server 210 and stored in databases 215, 220 and may serve as the basis for the conditional probabilities utilized in the embodiment methods.

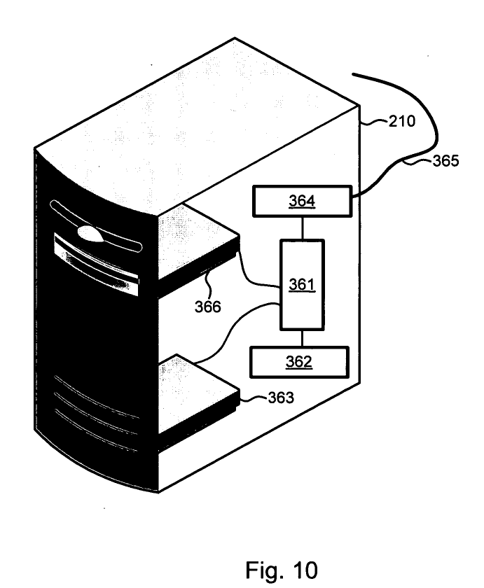

A number of the embodiments described above may also be implemented with any of a variety of remote server devices, such as the server 210 illustrated in FIG. 10. Such a remote server 210 typically includes a processor 361 coupled to volatile memory 362 and a large capacity nonvolatile memory, such as a disk drive 363. The server 210 may also include a floppy disc drive and/or a compact disc (CD) drive 366 coupled to the processor 361. Typically, the server 210 may also include a user input device like a keyboard (not shown) and a display (not shown). The server 210 may also include a number of connector ports coupled to the processor 361 for establishing data connections or receiving external memory devices, such as USB or FireWire® connector sockets or other network connection circuits 365 for coupling the processor 361 to a network 205.

The foregoing method descriptions and the process flow diagrams are provided merely as illustrative examples and are not intended to require or imply that the steps of the various embodiments must be performed in the order presented. As will be appreciated by one of skill in the art, the order of steps in the foregoing embodiments may be performed in any order.

The hardware used to implement the foregoing embodiments may be processing elements and memory elements configured to execute a set of instructions, including microprocessor units, microcomputer units, programmable floating point gate arrays (FPGA), and application specific integrated circuits (ASIC) as would be appreciated by one of skill in the art, wherein the set of instructions are for performing method steps corresponding to the above methods. Alternatively, some steps or methods may be performed by circuitry that is specific to a given function.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for inferring a mobile device user profile property classification, comprising:
logging at least one category of mobile device usage events; and
inferring the mobile device user profile property classification based upon the logged mobile device usage events and information derived from a population of users.

2. The method of claim 1, further comprising determining a behavior category classification based upon the logged mobile device usage events.

3. The method of claim 2 wherein inferring the mobile device user profile property classification based upon the logged mobile device usage events further comprises:
retrieving a probability of the user being a member of each of a plurality of mobile device user profile property classifications from a first table of derived information;
retrieving a first conditional probability of the user being a member of the behavior category classification given the mobile device user profile property classification from a second table of derived information;
calculating a plurality of relative likelihood values as a product of the probability of the user being a member of each of the mobile device user profile property classifications and the first conditional probability of the user being a member of the behavior category classification; and
identifying the mobile device user profile property classification as one that yields a maximum relative likelihood.

4. The method of claim 3, further comprising determining a plurality of behavior category classifications based upon the logged mobile device usage events.

5. The method of claim 2, wherein inferring the mobile device user profile property classification based upon of the logged mobile device usage events further comprises:
determining a plurality of behavior category classifications based upon of the logged mobile device usage events;
retrieving a probability of the user being a member of each of a plurality of mobile device user profile property classifications from a first table of derived information;
retrieving a plurality of conditional probability values of a user being a member of each of a plurality of mobile device user profile property classification given each of the plurality of behavior category classifications from a plurality of tables of derived information;
calculating a plurality of relative likelihood values as a product of the probability of the user being a member of each of the mobile device user profile property classifications and the conditional probability values of the user being a member of each of a plurality of mobile device user profile property classifications given each of the plurality of behavior category classifications; and
identifying the mobile device user profile property classification as one that yields a maximum relative likelihood value.

6. The method of claim 5, wherein said calculating the relative likelihood value of the user being a member of each of the plurality of mobile device user profile property classifications given the combination of the plurality of determined behavior category classifications comprises:
calculating a usage behavior product; and
multiplying the usage behavior product by a probability of the user being a member of the mobile device user profile property classification.

7. The method of claim 2, wherein inferring the mobile device user profile property classification based upon the logged mobile device usage events and information derived from the population of users comprises:
looking up the user demographic category classification in a derived inference table using the determined behavior category classification.

8. The method of claim 2, further comprising:
transmitting the determined behavior category classifications from the mobile device to a remote server configured to look up the inferred mobile device user profile property classification in a derived inference table using the received determined behavior category classification and transmit the inferred mobile device user profile property classification to the mobile device; and
receiving in the mobile device the inferred mobile device user profile property classification.

9. The method of claim 2, wherein determining the behavior category classification based upon the logged mobile device usage events further comprises:
determining whether sufficient mobile device usage events have been logged to accurately determine the behavior category classification; and
performing a statistical analysis of the logged mobile device usage events to determine the behavior category classification.

10. A method for inferring a mobile device user profile property classification, comprising:
receiving a determined behavior category classification from the mobile device;
retrieving from a derived inference table a mobile device user profile property classification using the received determined behavior category classification as a look up value; and
transmitting the inferred mobile device user profile property classification to the mobile device.

11. The method of claim 1, wherein said inferring the mobile device user profile property classification based upon the logged mobile device usage events and information derived from a population of users is performed by applying Bayesian probability principles.

12. A mobile device comprising:
means for logging at least one category of mobile device usage events; and
means for inferring the mobile device user profile property classification based upon the logged mobile device usage events and information derived from a population of users.

13. The mobile device of claim 12, further comprising means for determining a behavior category classification based upon the logged mobile device usage events.

14. The mobile device of claim 13 wherein said means for inferring the mobile device user profile property classification based upon the logged mobile device usage events further comprises:
means for retrieving a probability of the user being a member of each of a plurality of mobile device user profile property classifications from a first table of derived information;
means for retrieving a first conditional probability of the user being a member of the behavior category classification given the mobile device user profile property classification from a second table of derived information;
means for calculating a plurality of relative likelihood values as a product of the probability of the user being a member of each of the mobile device user profile property classifications and the first conditional probability of the user being a member of the behavior category classification; and
means for identifying the mobile device user profile property classification as one that yields a maximum relative likelihood.

15. The mobile device of claim 14, further comprising means for determining a plurality of behavior category classifications based upon the logged mobile device usage events.

16. The mobile device of claim 13, wherein said means for inferring the mobile device user profile property classification based upon the logged mobile device usage events further comprises:
means for determining a plurality of behavior category classifications based upon the logged mobile device usage events;
means for retrieving a probability of the user being a member of each of a plurality of mobile device user profile property classifications from a first table of derived information;
means for retrieving a plurality of conditional probability values of a user being a member of each of a plurality of mobile device user profile property classifications given each of the plurality of behavior category classifications from a plurality of tables of derived information;
means for calculating a plurality of relative likelihood values as a product of the probability of the user being a member of each of the mobile device user profile property classifications and the conditional probability values of the user being a member of each of a plurality of mobile device user profile property classifications given each of the plurality of behavior category classifications; and
means for identifying the mobile device user profile property classification as one that yields a maximum relative likelihood value.

17. The mobile device of claim 16, wherein said means for calculating the relative likelihood value of the user being a member of each of the plurality of mobile device user profile property classifications given the combination of the plurality of determined behavior category classifications comprises:
means for calculating a usage behavior product; and
means for multiplying the usage behavior product by a probability of the user being a member of the mobile device user profile property classification.

18. The mobile device of claim 13, wherein said means for inferring the user mobile device user profile property classification based upon the logged mobile device usage events comprises:
means for looking up the mobile device user profile property classification in a derived inference table using the determined behavior category classification.

19. The mobile device of claim 13, further comprising:
means for transmitting the determined behavior category classifications from the mobile device to a remote server; and
means for receiving the inferred mobile device user profile property classification from the remote server.

20. The mobile device of claim 13, wherein said means for determining the behavior category classification based upon the logged mobile device usage events further comprises:
means for determining whether sufficient mobile device usage events have been logged to accurately determine the behavior category classification; and
means for performing a statistical analysis of the logged mobile device usage events to determine the behavior category classification.

21. A remote server comprising:
means for receiving a determined behavior category classification from a mobile device;
means for retrieving from a derived inference table a mobile device user profile property classification using the received determined behavior category classification as a look up value; and
means for transmitting the inferred mobile device profile property classification to the mobile device.

22. The mobile device of claim 12, wherein said means for inferring the mobile device user profile property classification based upon the logged mobile device usage events and information derived from a population of users further comprises means for inferring the mobile device user profile property classification through the application of Bayesian probability principles.

23. A mobile device, comprising:
a memory unit; and
a processor coupled to the memory unit, wherein the processor is configured with software instructions to perform steps comprising:
logging at least one category of mobile device usage events in the memory unit; and
inferring a mobile device profile property classification based upon the logged mobile device usage events and information derived from a population of users.

24. The mobile device of claim 23, wherein the processor is configured with software instructions to perform further steps comprising:
determining a behavior category classification based upon the logged mobile device usage events.

25. The mobile device of claim 24, wherein the processor is configured with software instructions to perform further steps comprising:
retrieving a probability of the user being a member of each of a plurality of user profile property classifications from a first table of derived information;
retrieving a first conditional probability of the user being a member of the behavior category classification given the mobile device user profile property classification from a second table of derived information;
calculating a plurality of relative likelihood values as a product of the probability of the user being a member of each of the mobile device user profile property classifications and the first conditional probability of the user being a member of the behavior category classification; and
identifying the mobile device user profile property classification as one that yields a maximum relative likelihood.

26. The mobile device of claim 25, wherein the processor is configured with software instructions to perform further steps comprising:
determining a plurality of behavior category classifications based upon the logged mobile device usage events.

27. The mobile device of claim 24, wherein the processor is configured with software instructions to perform further steps comprising:
determining a plurality of behavior category classifications based upon of the logged mobile device usage events;
retrieving a probability of the user being a member of each of a plurality of mobile device user profile property classifications from a first table of derived information;
retrieving a plurality of conditional probability values of a user being a member of each of a plurality of mobile device user profile property classifications given each of the plurality of behavior category classifications from a plurality of tables of derived information;
calculating a plurality of relative likelihood values as a product of the probability of the user being a member of each of the mobile device user profile property classifications and the conditional probability values of the user being a member of each of a plurality of mobile device user profile property classifications given each of the plurality of behavior category classifications; and
identifying the mobile device user profile property classification as one that yields a maximum relative likelihood value.

28. The mobile device of claim 27, wherein the processor is configured with software instructions to perform further steps comprising:
calculating a usage behavior product; and
multiplying the usage behavior product by a probability of the user being a member of the mobile device user profile property classification.

29. The mobile device of claim 24, wherein the processor is configured with software instructions to perform further steps comprising:
looking up the mobile device user profile property classification in a derived inference table using the determined behavior category classification.

28. The mobile device of claim 22, wherein the processor is configured with software instructions to perform further steps comprising:
transmitting the determined behavior category classifications from the mobile device to a remote server configured to look up the inferred mobile device user profile property classification in a derived inference table using the received determined behavior category classification and transmit the inferred mobile device user profile property classification to the mobile device; and
receiving in the mobile device the inferred mobile device profile property classification.

31. The mobile device of claim 24, wherein the processor is configured with software instructions to perform further steps comprising:
determining whether sufficient mobile device usage events have been logged to accurately determine the behavior category classification; and
performing a statistical analysis of the logged mobile device usage events to determine the behavior category classification.

32. The mobile device of claim 23, wherein the processor is configured with software instructions to perform further steps comprising:
applying Bayesian probability principles to infer the mobile device user profile property classification based upon the logged mobile device usage events and information derived from a population of users.

33. A remote server comprising:
a remote server memory unit;
a remote server processing unit coupled to the remote server memory unit, wherein the remote server processor is configured with software instructions to perform steps comprising
receiving a determined behavior category classification from a mobile device;
retrieving from a derived inference table the mobile device user profile property classification using the received determined behavior category classification as a look up value; and
transmitting the inferred mobile device user profile property classification to the mobile device.

34. A tangible storage medium having stored thereon processor-executable software instructions configured to cause a processor to perform steps comprising:
logging at least one category of mobile device usage events; and
inferring a mobile device user profile property classification based upon the logged mobile device usage events and information derived from a population of users.

35. The tangible storage medium of claim 34, wherein the tangible storage medium has processor-executable software instructions configured to cause a processor to perform further steps comprising:
determining a behavior category classification based upon the logged mobile device usage events.

36. The tangible storage medium of claim 35, wherein the tangible storage medium has processor-executable software instructions configured to cause a processor to perform further steps comprising:
retrieving a probability of the user being a member of each of a plurality of mobile device user profile property classifications from a first table of derived information;
retrieving a first conditional probability of the user being a member of the behavior category classification given the mobile device user profile property classification from a second table of derived information;
calculating a plurality of relative likelihood values as a product of the probability of the user being a member of each of the mobile device user profile property classifications and the first conditional probability of the user being a member of the behavior category classification; and
identifying the mobile device user profile property classification as one that yields a maximum relative likelihood.

37. The tangible storage medium of claim 35, wherein the tangible storage medium has processor-executable software instructions configured to cause a processor to perform further steps comprising:
determining a plurality of behavior category classifications based upon the logged mobile device usage events.

38. The tangible storage medium of claim 35, wherein the tangible storage medium has processor-executable software instructions configured to cause a processor to perform further steps comprising:
determining a plurality of behavior category classifications based upon of the logged mobile device usage events;
retrieving a probability of the user being a member of each of a plurality of mobile device user profile property classifications from a first table of derived information;
retrieving a plurality of conditional probability values of a user being a member of each of a plurality of mobile device user profile property classifications given each of the plurality of behavior category classifications from a plurality of tables of derived information;
calculating a plurality of relative likelihood values as a product of the probability of the user being a member of each of the mobile device user profile property classifications and the conditional probability values of the user being a member of each of a plurality of mobile device user profile property classifications given each of the plurality of behavior category classifications; and
identifying the demographic category classification as one that yields a maximum relative likelihood value.

39. The tangible storage medium of claim 38, wherein the tangible storage medium has processor-executable software instructions configured to cause a processor to perform further steps comprising:
calculating a usage behavior product; and
multiplying the usage behavior product by a probability of the user being a member of the mobile device user profile property classification.

40. The tangible storage medium of claim 35, wherein the tangible storage medium has processor-executable software instructions configured to cause a processor to perform further steps comprising:
looking up the mobile device user profile property classification in a derived inference table using the determined behavior category classification.

41. The tangible storage medium of claim 35, wherein the tangible storage medium has processor-executable software instructions configured to cause a processor to perform further steps comprising:
transmitting the determined behavior category classifications from the mobile device to a remote server configured to look up the inferred mobile device user profile property classification in a derived inference table using the received determined behavior category classification and transmit the inferred mobile device user profile property classification to the mobile device; and
receiving in the mobile device the inferred mobile device user profile property classification.

42. The tangible storage medium of claim 35, wherein the tangible storage medium has processor-executable software instructions configured to cause a processor to perform further steps comprising:
determining whether sufficient mobile device usage events have been logged to accurately determine the behavior category classification; and
performing a statistical analysis of the logged mobile device usage events to determine the behavior category classification.

43. The tangible storage medium of claim 35, wherein the tangible storage medium has processor-executable software instructions configured to cause a processor to perform further steps comprising:
applying Bayesian probability principles to infer the mobile device user profile property classification based upon the logged mobile device usage events and information derived from a population of users.

44. A tangible storage medium having stored thereon processor-executable software instructions configured to cause a processor to perform steps comprising:
receiving a determined behavior category classification from a mobile device;
retrieving from an inference table a mobile device user profile property classification using the received determined behavior category classification as a look up value; and
transmitting the inferred mobile device user profile property classification to the mobile device.

45. A system for inferring mobile device user profile property classification comprising:
at least one mobile device configured to log at least one category of mobile device usage events occurring on the mobile device and determine at least one behavior category classification based upon the logged mobile device usage events;
a remote server; and
a communication network connecting the at least one mobile device with the remote server,
wherein:
the at least one mobile device is further configured to transmit the determined at least one behavior category classification to the remote server via the communication network;
the remote server is configured to:
receive the determined at least one behavior category classification;
infer the mobile device user profile property classification based upon the logged mobile device usage events; and
transmit the inferred mobile device user profile property classification to the mobile device via the communication network; and
the at least one mobile device is further configured to receive the inferred mobile device user profile property classification.

46. The system of claim 45, wherein said remote server is configured to infer the mobile device user profile property classification by looking up the inferred mobile device user profile property classification in a derived inference table based upon the received determined at least one behavior category classification

47. The system of claim 45, wherein said remote server is configured to infer the mobile device user profile property classification by
retrieving a probability of the user being a member of each of a plurality of mobile device user profile property classifications from a first table of derived information;
retrieving a conditional probability values of a user being a member of each of a plurality of mobile device user profile property classifications given each of the at least one behavior category classifications from at least one table of derived information;
calculating a plurality of relative likelihood values as a product of the probability of the user being a member of each of the mobile device user profile property classifications and the conditional probability values of the user being a member of each of a plurality of mobile device user profile property classifications given each of the at least one behavior category classifications; and
identifying the mobile device user profile property classification as one that yields a maximum relative likelihood value.

48. The system of claim 45, wherein said at least one mobile device is further configured to:
determine whether sufficient mobile device usage events have been logged to accurately determine the behavior category classification; and
perform a statistical analysis of the logged mobile device usage events to determine the behavior category classification.
